(19) United States
(12) Patent Application Publication
(10) Pub. No.: US 2025/0217538 A1
(43) Pub. Date: Jul. 3, 2025

(54) SIMULATION PROGRAM, RECORDING MEDIUM, SIMULATION METHOD, AND SIMULATION DEVICE

(71) Applicant: KOMATSU INDUSTRIES CORPORATION, Kanazawa-shi, Ishikawa (JP)

(72) Inventors: Hidetoshi AKASHI, Ishikawa (JP); Shigeru NAKAYAMA; Yuji SAKAGUCHI, Ishikawa (JP)

(21) Appl. No.: 18/847,829

(22) PCT Filed: Apr. 21, 2023
(86) PCT No.: PCT/JP2023/015998

§ 371 Date: Mar. 17, 2025

(30) Foreign Application Priority Data
Jun. 23, 2022 (JP) 2022-101086

(51) Int. Cl. G06F 30/17

(52) U.S. Cl. CPC G06F 30/17

(57) ABSTRACT

The simulation program is a simulation program that simulates a motion of a press line including press devices (1P to 5P) that press a workpiece (W) and includes a step (S1) and steps (S2 to S4). In step (S1), the motion of the press line (1) is generated. In steps (S2 to S4), information regarding power consumption of the press line (1) is calculated based on the motion of the press line (1).

### TECHNICAL FIELD

The present invention relates to a simulation program, a recording medium, a simulation method, and a simulation device.

### BACKGROUND ART

For example, a tandem press line is used for molding an automobile body. In the tandem press line, a plurality of press device are installed side by side, and feeder devices (conveying devices) for conveying workpieces are provided between the press devices.

In such press lines, a press line simulator is used to generate appropriate forming motions and conveying motions while avoiding interference between the press device and the feeder device (see, for example, Patent Document 1).

### CITATION LIST

### Patent Literature

Patent Literature 1: Japan Laid-open Patent Application Publication 2018-0161657

### SUMMARY OF INVENTION

In conventional press line operation, the focus has been on how to increase productivity, but with the recent trend toward carbon neutrality, attention is also being paid to reducing energy consumption.

It is an object of the present invention to provide a simulation program, a recording medium, a simulation method, and a simulation device, whereby it is made possible to confirm information serving as an index of energy consumption.

### Solution to Problem

A simulation program according to a first disclosure is a simulation program that simulates a motion of a press line equipped with a first press device that presses a workpiece, and causes a computer to execute a motion generation step and a power consumption information calculation step. In the motion generation step, the motion of the press line is generated. In the power consumption information calculation step, information regarding power consumption of the press line is calculated based on the motion of the press line.

A simulation method according to a second disclosure is a simulation method for simulating a motion of a press line equipped with a first press device that presses a workpiece, and includes a motion generation step and a power consumption information calculation step. In the motion generation step, the motion of the press line is generated. In the power consumption information calculation step, information regarding power consumption of the press line is calculated based on the motion of the press line.

A simulation device according to a third disclosure is a simulation device that simulates a motion of a press line equipped with a first press device that presses a workpiece, and includes a motion generation section and a power consumption information calculation section. The motion generation section generates the motion of the press line. The power consumption information calculation section calculates information regarding power consumption of the press line based on the motion of the press line.

### Advantageous Effect of Invention

According to the present invention, it made possible to provide a simulation program, a recording medium, a simulation method, and a simulation device, whereby it is made possible to confirm information serving as an index of energy consumption.

### BRIEF DESCRIPTION OF THE DRAWINGS

FIG. 1 is a diagram showing a press line according to an embodiment of the present disclosure.

FIG. 2 is a diagram showing a configuration of a press device according to the embodiment of the present disclosure.

FIG. 3 is a diagram showing configurations of one set of a servo motor and a transmission mechanism according to the embodiment of the present disclosure.

FIG. 4 is a perspective view showing a configuration of a feeder device according to the embodiment of the present disclosure.

FIG. 5 is a block diagram showing a configuration of a simulation device according to the embodiment of the present disclosure.

FIG. 6 is a flow diagram showing a simulation method according to the embodiment of the present disclosure.

FIG. 7 is composed of diagrams (a) to (e) provided as a view showing motions and workloads of feeders and press devices and a diagram (f) provided as a view showing motions of feeders and press devices and a workload of the press line.

FIG. 8 is a flowchart showing calculation of a workload of the press device according to the embodiment of the present disclosure.

FIG. 9 is composed of a diagram (a) provided as a view showing a slide motion of the press device according to the embodiment of the present disclosure, and a diagram (b) provided as a view showing a motion of the servo motor for realizing the motion of the diagram (a).

FIG. 10 is composed of a diagram (a) provided as a view showing a change in torque of the servo motor over time, and a diagram (b) provided as a view showing the change in workload of the servo motor over time.

FIG. 11 is a diagram showing an example of a display screen displayed on a display section of the simulation device according to the embodiment of the present disclosure.

### DESCRIPTION OF EMBODIMENTS

A simulation program of the present disclosure will be described below with reference to the drawings.

First, a configuration of a press line that is simulated by the simulation program of the present disclosure will be described.

### Press Line 1

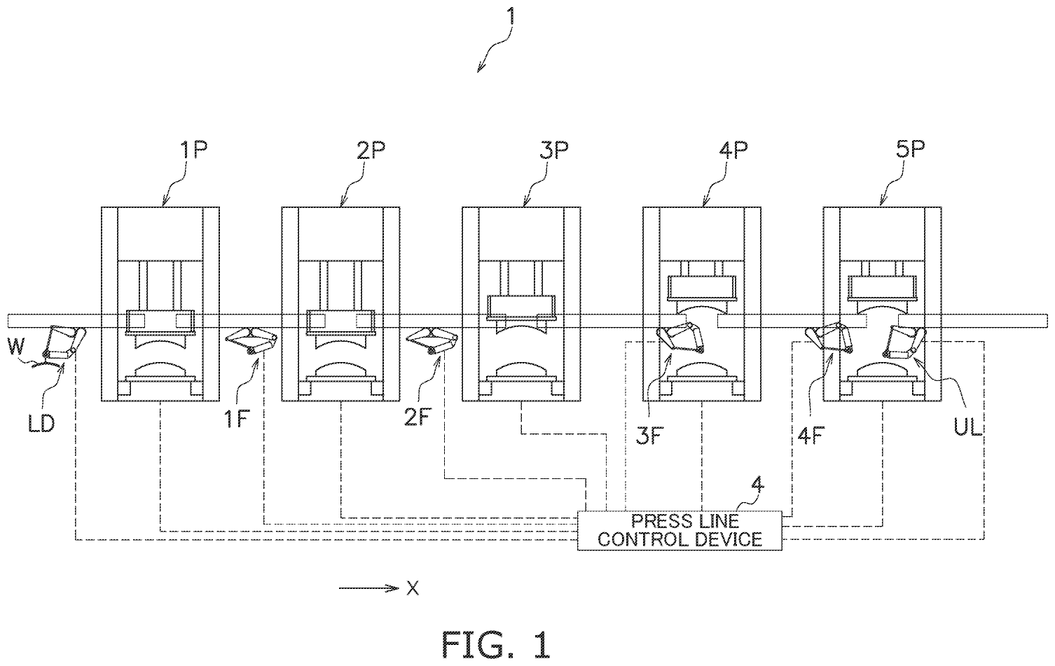

FIG. 1 is a schematic diagram showing the configuration of a press line 1 according to the embodiment of the present disclosure.

The press line 1 of the present embodiment performs press working in each press device and conveys the workpiece W between press devices by a feeder device. The conveying direction of the workpiece W is indicated as X in the diagrams.

The press line 1 is a tandem press line and includes a plurality of press devices 1P, 2P, 3P, 4P, and 5P, a plurality of feeder devices LD, 1F, 2F, 3F, 4F, and UL, and a press line control device 4. A plurality of press devices 1P, 2P, 3P, 4P, and 5P, a plurality of feeder devices LD, 1F, 2F, 3F, 4F, and UL, and the press line control device 4 are connected to the same factory power supply.

### Press Device 2

In the press line 1 of the present embodiment, as shown in FIG. 1, the press devices 1P, 2P, 3P, 4P, and 5P are arranged side by side along the work conveying direction X. The press devices 1P, 2P, 3P, 4P, and 5P have the same configuration. The press line 1 of the present embodiment includes five press devices. Any one of the press devices 1P, 2P, 3P, 4P, and 5P corresponds to an example of a first press device, and any one of the other corresponds to an example of a second press device.

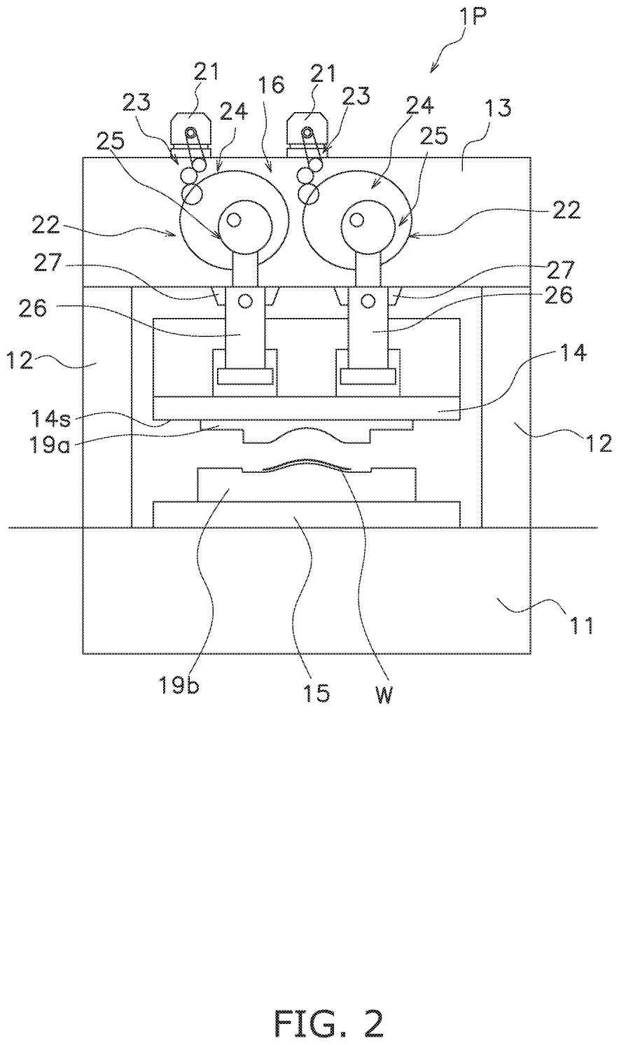

Since the press devices 1P, 2P, 3P, 4P, and 5P have the same configuration, the configuration will be described using the press device 1P as an example. FIG. 2 is a schematic diagram showing the configuration of the press device 1P. The press device 1P mainly includes a bed 11, uprights 12, a crown 13, a slide 14, a bolster 15, and a slide drive unit 16.

The bed 11 is embedded in the floor and forms the foundation of the press device 2. The uprights 12 are columnar members, and four uprights 12 are arranged on the bed 11. The four uprights 12 are arranged so as to form vertices of a rectangle in a plan view.

The crown 13 is supported above the bed 11 by the four uprights 12. The slide 14 is suspended below the crown 13 so as to be movable up and down. An upper die 19a is detachably attached to a lower surface 14s of the slide 14 by a die clamper (not shown). The bolster 15 is disposed below the slide 14 and on the bed 11. A lower die 19b is placed above the bolster 15.

The slide drive unit 16 is provided in the crown 13 and raises and lowers the slide 14 provided on the underside of the crown 13.

### Slide Drive Unit 16

The slide drive unit 16 is provided in the crown 13 and moves the slide 14 up and down. The slide drive unit 16 supports the slide 14 at four points. The slide drive unit 16 includes four servo motors 21 as driving sources, and four transmission mechanisms 22 that transmit the driving force of each servo motor 21 to the slide 14. Although only two servo motors 21 and two transmission mechanisms 22 are shown in FIG. 2, two more servo motors 21 and two more transmission mechanisms 22 are provided on the rear side of the page.

Each transmission mechanism 22 includes a first reducer 23 and a second reducer 24 that decelerate the rotation of each servo motor 21, a lifting section 25 that converts the decelerated rotational motion into reciprocating motion in the up and down direction, and a plunger 26 of which lower end is fixed to the slide 14 and that moves the slide 14 in the up and down direction.

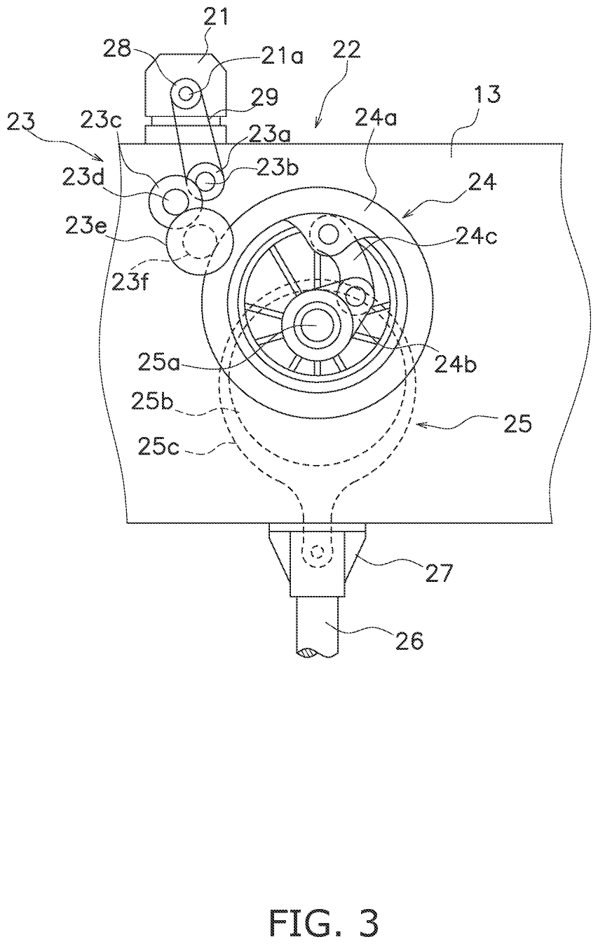

FIG. 3 is a diagram showing the configuration of one set of the servo motor 21 and the transmission mechanism 22. The servo motor 21 is attached to the crown 13 so that its drive shaft 21a is disposed horizontally.

The first reducer 23 is a uniform speed reducer and is connected to the drive shaft 21a of the servo motor 21. The first reducer 23 includes a large pulley 23a, a first pinion 23b, a first gear 23c, a second pinion 23d, a second gear 23e, and a third pinion 23f. The rotation of a small pulley 28 fixed to the drive shaft 21a of the servo motor 21 is transmitted to the large pulley 23a by a belt 29. The first pinion 23b is provided integrally with the large pulley 23a. The first gear 23c meshes with the first pinion 23b. The second pinion 23d is provided integrally with the first gear 23c. The second gear 23e meshes with the second pinion 23d. The third pinion 23f is provided integrally with the second gear 23e. The third pinion 23f meshes with a large-diameter helical gear 24a that is arranged on the outer periphery of the second reducer 24.

The second reducer 24 is a Whitworth reducer that reduces the rotational speed during one rotation so that the rotational speed is non-uniform and transmits power to an eccentric shaft 25a of the lifting section 25. The second reducer 24 includes a helical gear 24a, a lever 24b, and a connecting member 24c. The helical gear 24a is ring-shaped and is arranged on the outer periphery portion of the second reducer 24. The lever 24b is fixed to the eccentric shaft 25a that protrudes horizontally from a frame of the crown 13. The connecting member 24c connects the lever 24b and the inner periphery of the helical gear 24a. The center of rotation of the helical gear 24a is disposed vertically above the axis of the eccentric shaft 25a.

The lifting section 25 includes the eccentric shaft 25a, an eccentric drum 25b, and a connecting rod 25c. The eccentric shaft 25a is supported by the frame of the crown 13 on both sides of the eccentric drum 25b (on the front side and the rear side in the direction perpendicular to the paper surface in FIG. 3). The eccentric drum 25b is formed in a disk shape eccentric to the eccentric shaft 25a and rotates eccentrically together with the rotation of the eccentric shaft 25a. The connecting rod 25c is connected to the eccentric drum 25b. A plunger 26 is connected to the lower part of the connecting rod 25c, and the slide 14 is attached to the lower part of the plunger 26.

A plunger holder 27 is fixed to the underside of the crown 13 and guides the plunger 26 in the up and down direction. It can be said that the plunger holder 27 restricts the horizontal movement of the plunger 26.

When the eccentric drum 25b of the lifting section 25 configured as described above rotates eccentrically, the connecting rod 25c swings, the plunger 26 moves up and down, and the slide 14 moves up and down. As the slide 14 moves up and down, the workpiece W is pressed by the upper die 19a and the lower die 19b.

### Feeder Device 3

In the press line 1 of the present embodiment, as shown in FIG. 1, the feeder devices LD, 1F, 2F, 3F, 4F, and UL are arranged along the work conveying direction X. The feeder devices LD, 1F, 2F, 3F, 4F, and UL have the same configuration. The press line 1 of the present embodiment is equipped with six feeder devices. Any one of the feeder devices LD, 1F, 2F, 3F, 4F, and UL corresponds to an example of a first conveying device.

As shown in FIG. 1, the feeder device LD is arranged upstream side of the press device 1P. The feeder device LD carries the workpiece W into the press device 1P. The feeder device 1F is arranged between the press device 1P and the press device 2P. The feeder device 1F conveys the workpiece W from the press device 1P to the press device 2P. The feeder device 2F is arranged between the press device 2P and the press device 3P. The feeder device 2F conveys the workpiece W from the press device 2P to the press device 3P. The feeder device 3F is arranged between the press device 3P and the press device 4P. The feeder device 3F conveys the workpiece W from the press device 3P to the press device 4P. The feeder device 4F is arranged between the press device 4P and the press device 5P. The feeder device 4F conveys the workpiece W from the press device 4P to the press device 5P. The feeder device UL is arranged downstream side of the press device 5P. The feeder device UL carries the workpiece W out from the press device 5P.

Since the feeder devices LD, 1F, 2F, 3F, 4F, and UL have the same configuration, the configuration will be described using the feeder device 1F as an example.

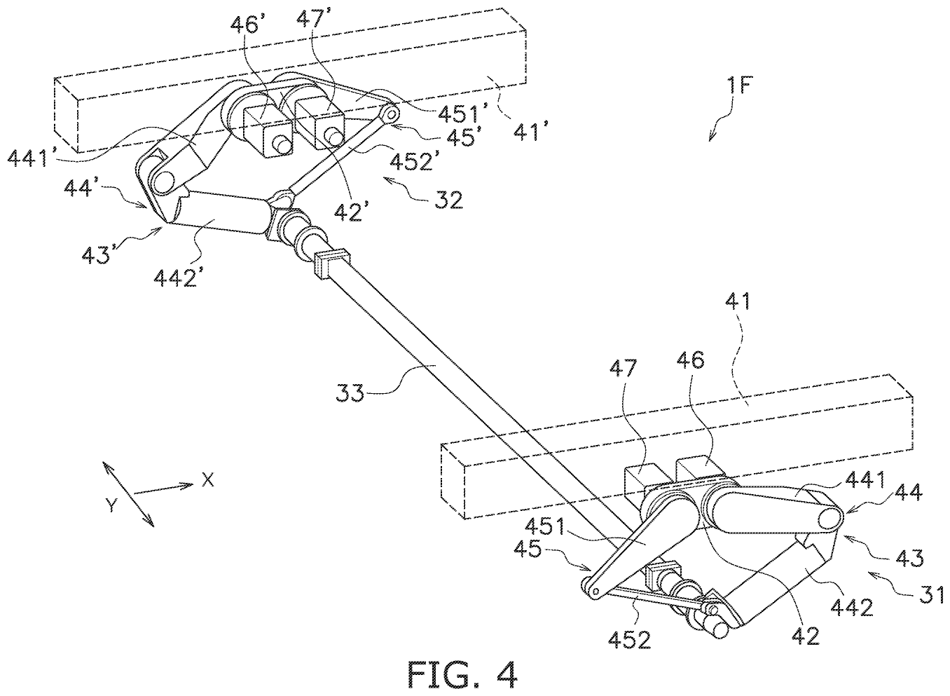

FIG. 4 is a perspective view showing the configuration of the feeder device 1F. The feeder device 1F includes a first drive device 31 arranged on one side in a width direction Y, and a second drive device 32 arranged on the other side in the width direction Y. The first drive device 31 includes a guide rail 41 extending in the conveying direction X. The second drive device 32 includes a guide rail 41′ extending in the conveying direction X. In FIG. 4, the guide rails 41, 41′ are indicated by dashed lines. The guide rails 41, 41′ are configured to be immovable. In the feeder device 1F, the guide rails 41, 41′ are arranged from the press device 1P to the press device 2P. In the feeder device LD, the guide rails 41, 41′ are disposed the upstream side of the press device 1P. In the feeder devices 2F to 4F, the guide rails 41, 41′ are disposed between the adjacent press devices, similarly to the feeder device 1F. In the feeder device UD, the guide rails 41, 41′ are disposed the downstream side of the press device 5P. The guide rails 41, 41′ are fixed, for example, to the uprights 12 of the press devices 1P to 5P.

The feeder device 1F further includes a crossbar 33. The crossbar 33 extends in the width direction Y. The crossbar 33 is disposed below the guide rails 41, 41′. One end of the crossbar 33 in the width direction Y is supported by the first drive device 31. The other end of the crossbar 33 in the width direction Y is supported by the second drive device 32. The crossbar 33 spans between the first drive device 31 and the second drive device 32.

The crossbar 33 holds a workpiece W (see FIG. 2) at a middle portion between one end and the other end. A conveyance tool (not shown) for holding the workpiece W is attached to the crossbar 33. An example of the conveyance tool is a vacuum cup that adsorbs the workpiece W. In adjacent press devices 2, after the press working of the workpiece is completed in the upstream press device 2, the crossbar 33 enters between the upper die 19a and the lower die 19b to hold the workpiece W. While the crossbar 33 holds the workpiece W, the first drive device 31 and the second drive device 32 move the crossbar 33 along a predetermined operating trajectory, thereby conveying the workpiece W from the upstream side press device 2 to the downstream side press device 2. The crossbar 33 enters between the upper die 19a and the lower die 19b of the downstream side press device 2 and releases the hold on the workpiece W, thereby conveying the workpiece W to the downstream side press device 2.

The first drive device 31 includes a base section 42. The base section 42 is supported by the guide rail 41. The base section 42 is attached to the lower surface of the guide rail 41. The base section 42 is suspended from the guide rail 41. In the present embodiment, the base section 42 is attached to the lower surface of the guide rail 41, but the base section may also be attached to the upper surface or the side surface of the guide rail 41.

The base section 42 is configured to be movable in the conveying direction X along the guide rail 41. A driving force for traveling is transmitted to the base section 42 from a driving source (not shown) such as a servo motor, whereby the base section 42 moves relative to the guide rail 41. The base section 42 reciprocates between both ends of the guide rail 41. The power transmission device that transmits the driving force for traveling to the base section 42 may include a rack and pinion mechanism, a timing belt, or a ball screw. The drive source for moving the base section 42 may be a linear motor.

The first drive device 31 includes a parallel mechanism 43. The parallel mechanism 43 is supported by the base section 42. The parallel mechanism 43 includes a first arm section 44 and a second arm section 45 that are parallel to each other.

The first arm section 44 includes a lever 441 and a link 442. The lever 441 is attached to the base section 42 so as to be rotatable relative to the base section 42. The lever 441 includes a base end attached to the base section 42 and a tip end opposite the base end. The link 442 is attached to the tip of the lever 441 so as to be rotatable relative to the lever 441. The link 442 includes a base end attached to the tip of the lever 441 and a tip opposite the base end. The end of the crossbar 33 is attached to the tip of the link 442. The crossbar 33 is supported at a tip portion of the parallel mechanism 43.

The second arm section 45 includes a lever 451 and a link 452. The lever 451 is attached to the base section 42 so as to be rotatable relative to the base section 42. The lever 451 includes a base end attached to the base section 42 and a tip end opposite the base end. The link 452 is attached to the tip of the lever 451 so as to be rotatable relative to the lever 451. The link 452 includes a base end attached to the tip of the lever 451 and a tip opposite the base end. The tip of the link 452 is not connected to the crossbar 33 but is connected to the link 442. The tip of the link 452 may be directly connected to the crossbar 33.

The first drive device 31 includes a first motor 46 and a second motor 47. The first motor 46 and the second motor 47 are, for example, servo motors. The first motor 46 and the second motor 47 generate driving force for driving the parallel mechanism 43.

The first motor 46 and the second motor 47 are mounted on the base section 42. The first motor 46 and the second motor 47 are arranged on the opposite side of the base section 42 from the first arm section 44 and the second arm section 45. The base section 42 is disposed between the first arm section 44 and the first motor 46, and between the second arm section 45 and the second motor 47.

The first motor 46 applies a driving force to the first arm section 44 to move the first arm section 44 relative to the base section 42. The second motor 47 applies a driving force to the second arm section 45 to move the second arm section 45 relative to the base section 42.

The parallel mechanism 43 receives driving forces from the first motor 46 and the second motor 47 and is operable within a plane defined by the convening direction X and the up and down direction. By the operation of the parallel mechanism 43, the relative position of the crossbar 33 attached to the tip of the link 442 with respect to the base section 42 is changed.

The second drive device 32 has the same configuration as the first drive device 31, and is arranged in a position inverted by 180 degrees from the first drive device 31. As shown in FIG. 4, each component of the second drive device 32 is given a reference number that is the same as the reference number given to the corresponding component of the first drive device 31 with a prime (′) added. A detailed description of the configuration of the second drive device 32 will be omitted since it overlaps with the description of the first drive device 31.

### Press Line Control Device 4

As shown in FIG. 1, the press line control device 4 controls the press devices 1P, 2P, 3P, 4P, and 5P and the feeder devices LD, 1F, 2F, 3F, 4F, and UL.

The press line control device 4 includes a processor and a memory. The processor is, for example, a CPU (Central Processing Unit). Alternatively, the processor may be a processor different from the CPU. The processor executes processing for controlling the press devices 1P to 5P and the feeder devices LD, 1F, 2F, 3F, 4F, and UL in accordance with a press line motion program recorded in the memory. The memory includes non-volatile memory such as Read Only Memory (ROM) and volatile memory such as Random Access Memory (RAM). The memory may include an auxiliary storage device such as a hard disk drive (HDD) or a solid state drive (SSD). The memory is an example of a non-transitory computer-readable storage medium. The press line motion program recorded in the memory is created by the simulation device 5, which will be described later. The press line control device 4 is connected to the simulation device 5 via wire or wirelessly so as to be able to receive data from the simulation device 5.

The press line control device 4 controls the press devices 1P to 5P. Specifically, the press line control device 4 sends commands to the four servo motors 21 provided in each of the press devices 1P to 5P to drive the servo motors 21, thereby controlling the press working.

The press line control device 4 controls the feeder devices LD, 1F, 2F, 3F, 4F, and UL. Specifically, the press line control device 4 sends commands to the first motor 46, the second motor 47, the servo motor that move the first drive device 31 in the conveying direction X, the first motor 46′, the second motor 47′, and the servo motor that move the second drive device 32 in the conveying direction X of each of the feeder devices LD, 1F, 2F, 3F, 4F, and UL, thereby driving the servo motors to convey the workpiece W.

### Simulation Device 5

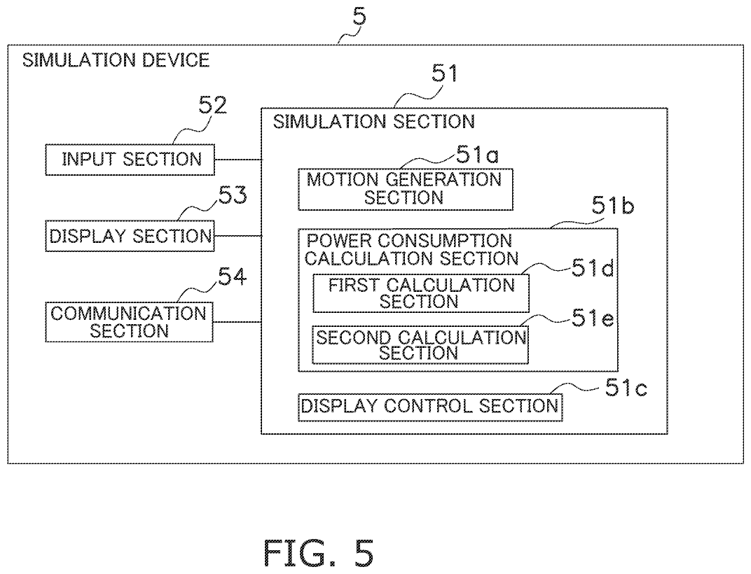

FIG. 5 is a block diagram showing the configuration of the simulation device 5. The simulation device 5 includes a simulation section 51, an input section 52, a display section 53, and a communication section 54. The simulation section 51 generates a motion of the press line 1 and calculates the power consumption of the press line 1 in that motion.

The input section 52 includes, for example, a keyboard and a mouse, and an operator inputs various settings using the input section 52 while looking at the display section 53. The operator uses the input section 52 to input data for generating the motion of the press line 1. This data may include shape data of the dies (upper die 19a and lower die 19b), shape data of the workpiece W, shape data of a workpiece conveyance tool, or the production speed of the press line 1, etc.

The simulation section 51 is, for example, a workstation (an example of a computer). The simulation section 51 includes a processor and a memory. The processor is, for example, a CPU (Central Processing Unit). Alternatively, the processor may be a processor different from the CPU. The processor generates the motion of the press line 1 according to a program recorded in the memory, and executes a process of calculating the power consumption in that motion. The memory includes non-volatile memory such as Read Only Memory (ROM) and volatile memory such as Random Access Memory (RAM). The memory may include an auxiliary storage device such as a hard disk drive (HDD) or a solid state drive (SSD). The memory is an example of a non-transitory computer-readable storage medium.

The simulation section 51 includes a motion generation section 51a, a power consumption calculation section 51b (an example of a power consumption information calculation section), and a display control section 51c. The processor executes a program recorded in the memory, causing the simulation section 51 to realize the functions of the motion generation section 51a, the power consumption calculation section 51b, and the display control section 51c.

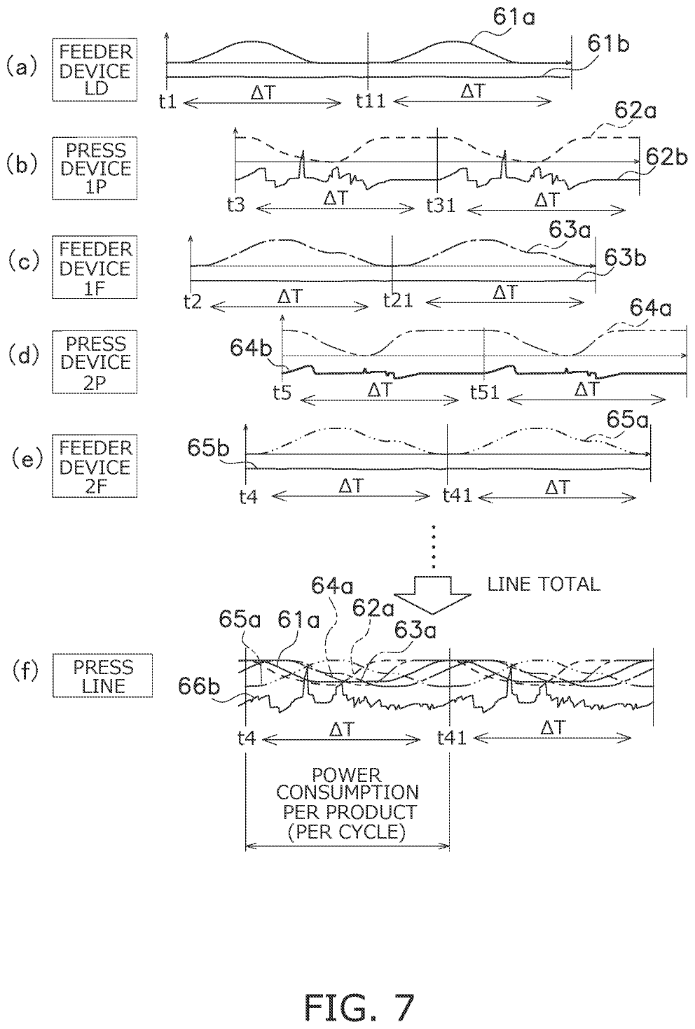

The memory records a plurality of slide motion data of the press device 2 and a plurality of feeder motion data of the feeder device 3. The motion generation section 51a generates the motion of the press line 1 from the slide motion data and the feeder motion data recorded in the memory based on the data input to the input section 52 while considering interference between the workpiece W and the dies. In the present embodiment, the motion generation section 51a generates a press line motion with phase differences between a plurality of press devices 2. As will be described later with reference to FIGS. 7(a) to 7(e), the phase difference means that the positions of the slides 14 at the same time are different among a plurality of press devices 2.

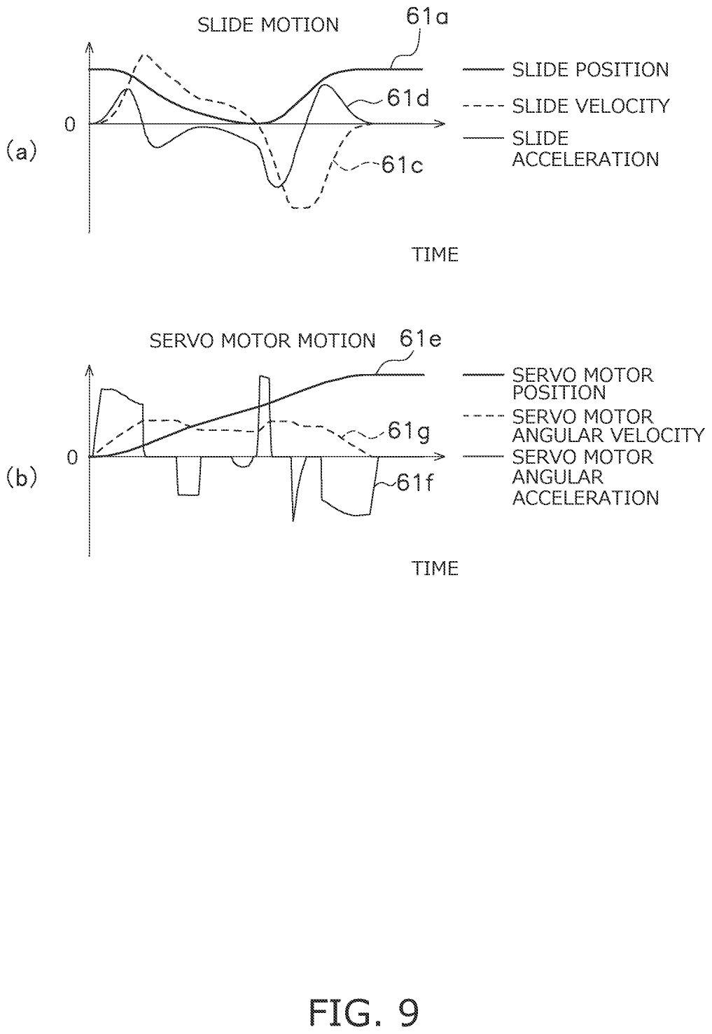

The power consumption calculation section 51b calculates the power consumption in the press line motion generated by the motion generation section 51a. The power consumption calculation section 51b includes a first calculation section 51d and a second calculation section 51e. The first calculation section 51d calculates the workload of each of the press devices 1P to 5P and the feeder devices LD, 1F, 2F, 3F, 4F, and UL in the press line motion generated by the motion generation section 51a. As will be described in detail later with reference to FIG. 9, the first calculation section 51d calculates, for the press device 2, the workload of the servo motor that executes the generated press line motion. The servo motors of the press device 2 are, for example. four servo motors 21. The first calculation section 51d calculates, for the feeder device 3, the workload of the servo motor that executes the generated press line motion. The servo motors of the feeder device 3 are, for example, the first motor 46, the second motor 47, and the servo motor that move the first drive device 31 along the conveying direction X, the first motor 46′, the second motor 47′, and the servo motor that move the second drive device 32 along the conveying direction X.

The second calculation section 51e calculates the power consumption per workpiece in the press line 1 from the workload in each of the press devices 1P to 5P and the feeder devices LD, 1F, 2F, 3F, 4F, and UL. Here, the power consumption per workpiece is the power consumption per cycle (one period).

The display control section 51c causes the display section 53 to display the amount of power consumption of the press line 1 calculated in the simulation section 51.

The display section 53 is, for example, a monitor. The display section 53 displays the power consumption of the press line 1 calculated by the simulation section 51 based on a control signal from the display control section 51c. The display section 53 may display the power consumption of each of the press devices 1P to 5P and the feeder devices LD, 1F, 2F, 3F, 4F, and UL, along with the power consumption of the press line 1.

The communication section 54 transmits the generated press line motion and the power consumption to the press line control device 4. The communication section 54 is connected to the press line control device 4 via wire or wirelessly. Alternatively, the press line motion generated by the simulation device 5 may be transferred to the press line control device 4 via a storage medium such as a USB memory.

### Simulation Method

Next, the simulation method will be described. The program of the present disclosure is a program executed by a computer to perform all or some of the steps of the following simulation method.

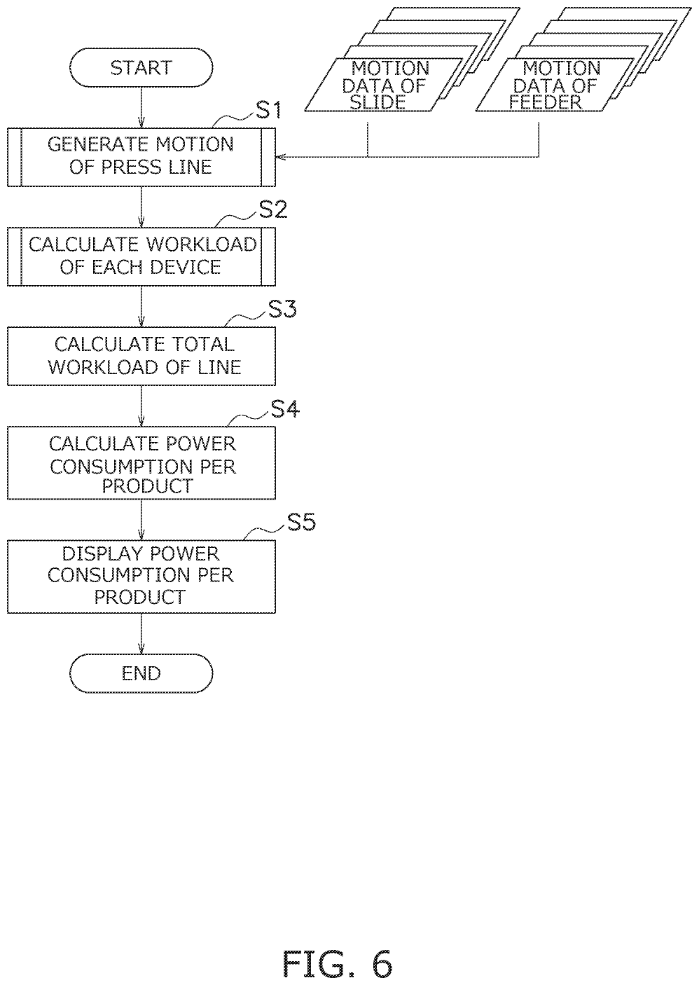

FIG. 6 is a flowchart showing a simulation method.

First, in step S1 (an example of a motion generation step), the motion generation section 51a generates the motion of the press line 1. The motion generation section 51a generates the motion of the press line 1 from the slide motion data and feeder motion data recorded in the memory based on the data input to the input section 52 while considering interference between the workpiece W and the die.

FIGS. 7 (a) to (e) are diagrams showing the motions of the feeder device LD, the press device 1P, the feeder device 1F, the press device 2P and the feeder device 2F. For ease of understanding, the motions of the feeder devices 3F, 4F, and UL and the press devices 3P. 4P, and 5P are omitted.

FIG. 7(a) is a diagram showing a graph 61a of the motion of the feeder device LD in the generated press line motion. The graph 61a is shown by a solid line. Below the graph 61a, a graph 61b showing the change over time in the workload of the feeder device LD is shown by a solid line. FIG. 7(b) is a diagram showing a graph 62a of the motion of the press device 1P in the generated press line motion. The Graph 62a is shown by a dashed line. Below the graph 62a, a graph 62b showing the change over time in the workload of the press device 1P is shown by a solid line. FIG. 7(c) is a diagram showing a graph 63a of the motion of the feeder device 1F in the generated press line motion. The graph 63a is shown by an alternate long and short dash line. Below the graph 63a, a graph 63b showing the change over time in the workload of the feeder device 1F is shown by a solid line. FIG. 7(d) is a diagram showing a graph 64a of the motion of the press device 2P in the generated press line motion. The graph 64a is shown by an alternate long and two short dashes line. Below the graph 64a, a graph 64b showing the change over time in the workload of the press device 2P is shown by a solid line. FIG. 7(e) is a diagram showing a graph 65a of the motion of the feeder device 2F in the generated press line motion. The graph 65a is shown by an alternate long and two short dashes line. Below the graph 65a, a graph 65b showing the change over time in the workload of the feeder device 2F is shown by a solid line.

In the diagrams showing the motions of the feeder devices LD. 1F, and 2F shown in FIGS. 7(a), 7(c), and 7(e), the vertical axis represents the position of the crossbar 33 in the conveying direction X, and the horizontal axis represents time. In the feeder device, the crossbar 33 moves not only in the conveying direction X but also in the up and down direction. However, the amount of up and down movement is smaller than the movement in the conveying direction, and the impact on the workload of the device described below is small. In the diagrams showing the motions of the press devices 1P and 2P shown in FIGS. 7(b) and 7(d), the vertical axis represents the up and down position of the slide 14, and the horizontal axis represents time.

The press devices 1P to 5P repeat a predetermined motion for each cycle. The feeder devices LD, 1F, 2F, 3F, 4F, and UL repeat a predetermined motion for each period.

The times in FIGS. 7(a) to 7(e) will now be described. In the case that the time when the first cycle of the motion of the feeder device LD starts is t1, then after the start of the motion of the feeder device LD, the first cycle of the motion of the feeder device 1F starts at time t2. After time t2, at time t3, the first cycle of the motion of the press device 1P starts. After time t3, at time t4, the first cycle of the motion of the feeder device 2F starts. After time t4, at time t5, the first cycle of the motion of the press device 2P starts.

At time t11, the first cycle of the motion of the feeder device LD ends and the second cycle of the motion of the feeder device LD starts. After time t11, at time t21, the first cycle of the motion of the feeder device 1F ends and the second cycle of the motion of the feeder device 1F starts. After time t21, at time t31, the first cycle of the motion of the press device 1P ends and the second cycle of the motion of the press device 1P starts. After time t31, at time t41, the first cycle of the motion of the feeder device 2F ends and the second cycle of the motion of the feeder device 2F starts. After time t41, at time t51, the first cycle of the motion of the press device 2P ends and the second cycle of the motion of the press device 2P starts. The duration of one cycle of each of the press devices 1P to 5P and the feeder devices LD, 1F, 2F, 3F, 4F, and UL is the same. In FIG. 7(a) to FIG. 7(e), time t1 to time t11, time t2 to time t21, time t3 to time t31, time t4 to time t41, and time t5 to time t51 each have the same time ΔT.

Each of the press devices 1P to 5P and the feeder devices LD, 1F, 2F, 3F, 4F, and UL repeats a predetermined motion with a cycle ΔT, so that the workpiece W is conveyed in the conveying direction X by the feeder devices LD, 1F, 2F, 3F, 4F, and UL while being processed sequentially by the press devices 1P to 5P.

As can be seen from FIGS. 7(b) and 7(d), the timing at which the cycle of the motion of the press device 1P starts is different from the timing at which the cycle of the motion of the press device 2P starts. That is, a phase difference is provided between the motion of the press device 1P and the motion of the press device 2P. As described above, the phase difference means that the positions of the slides 14 at the same time are different among the press devices 1P to 5P. As shown in FIGS. 7(b) and 7(d), at a time when the slide 14 of the press device 1P is in the middle of descending from the top dead center, the slide 14 of the press device 2P starts to descend from the top dead center. In this manner, in the present embodiment, phase differences are provided among a plurality of press devices 1P to 5P. It is not necessary to provide phase differences between all of the press devices 1P to 5P, and a phase difference may be provided between at least two of the press devices. In order to ensure high productivity, it is common to operate the presses with a phase difference as described above, but it is not always necessary to provide the phase difference.

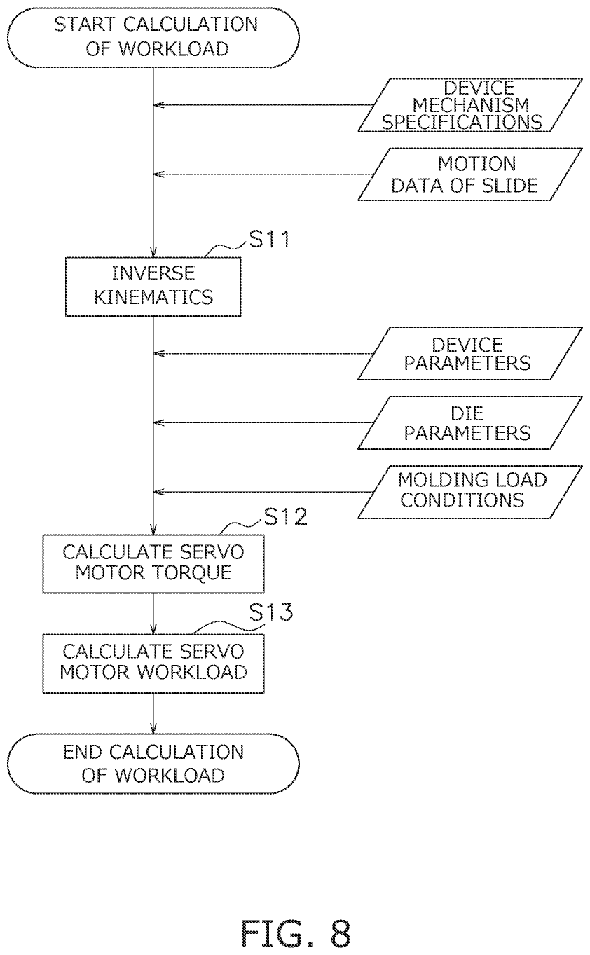

Returning to FIG. 6, in step S2 (an example of a first calculation step), the first calculation section 51d calculates the workload in each of the press devices 1P to 5P and the feeder devices LD, 1F, 2F, 3F, 4F, and UL. FIG. 8 is a flowchart showing the calculation of the workload in the press device 2.

In the workload calculation, first, inverse kinematics is executed in step S11. In inverse kinematics, workload is calculated from the motion. The simulation section 51 records specification information of the mechanisms of the press devices 1P to 5P, The specification information includes the reduction ratio of the servo motor 21, the length of the link and the connecting rod, the drum eccentric shaft, and the like.

The first calculation section 51d calculates a motion of a servo motor for executing a slide motion in the press line motion generated by the motion generation section 51a, based on specification information of the mechanism of the press device.

FIG. 9(a) is a diagram showing the slide motion of the press device 1P. Specifically. FIG. 9(a) shows a graph 61a (thick solid line) indicating the change over time in the slide position of the press device 1P, a graph 61c (dashed line) indicating the change over time in the slide velocity, and a graph 61d (thin solid line) indicating the change over time in the slide acceleration. The horizontal axis of the graph in FIG. 9(a) represents time. The vertical axis in FIG. 9(a) represents the up and down position of the slide for the graph 61a, the velocity of the slide for the graph 61c, and the acceleration of the slide for the graph 61d. The graphs 61c and 61d can be calculated from the graph 61a.

FIG. 9(b) is a diagram showing the motion of the servo motor 21 for realizing the motion in FIG. 9(a). The first calculation section 51d calculates the motion of the servo motor from the slide motion shown in FIG. 9(a) based on the specification information of the mechanism of the press device. FIG. 9(b) shows a graph 61e (thick solid line) indicating the change in angle of the servo motor 21 over time, a graph 61g (dashed line) indicating the change in angular velocity of the servo motor 21 over time, and a graph 61f indicating the change in angular acceleration (thin solid line) of the servo motor 21 over time.

Returning to the workload calculation in FIG. 8, in step S12, the first calculation section 51d calculates the torque of the servo motor when executing the calculated servo motor motion. The first calculation section 51d calculates the torque of the servo motor based on the motion of the servo motor, the device parameters, the die parameters, and the molding load conditions. The device parameters include the moment of inertia of the gears and drums used in the transmission mechanism 22.

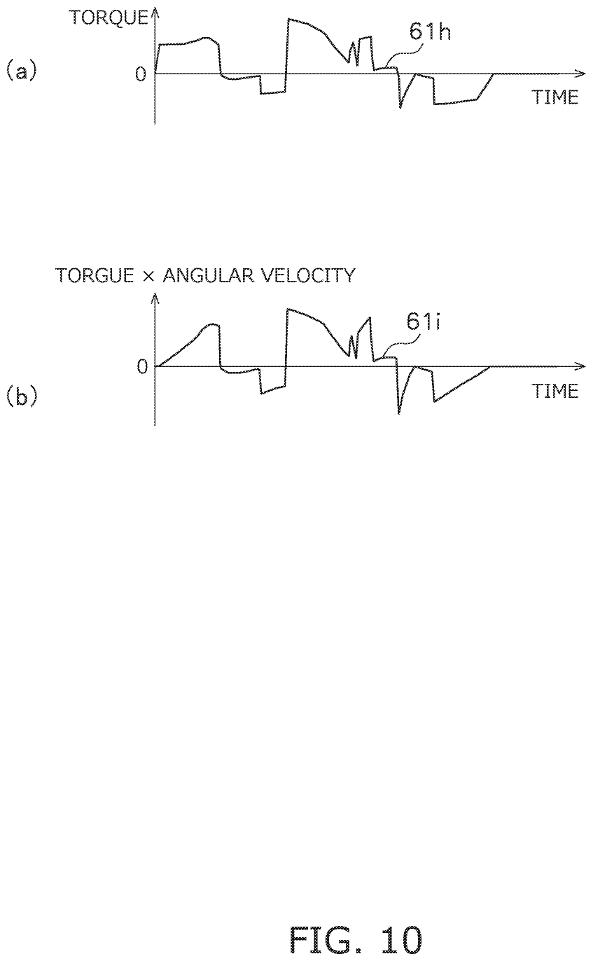

The die parameters include the mass of the upper die 19a and the pressure of the balancer. The molding load conditions include a molding load, a die cushion load, and a die cushion stroke. FIG. 10(a) is a diagram showing a graph 61h indicating the change in torque of the servo motor over time. In FIG. 10(a), the vertical axis represents torque, and the horizontal axis represents time.

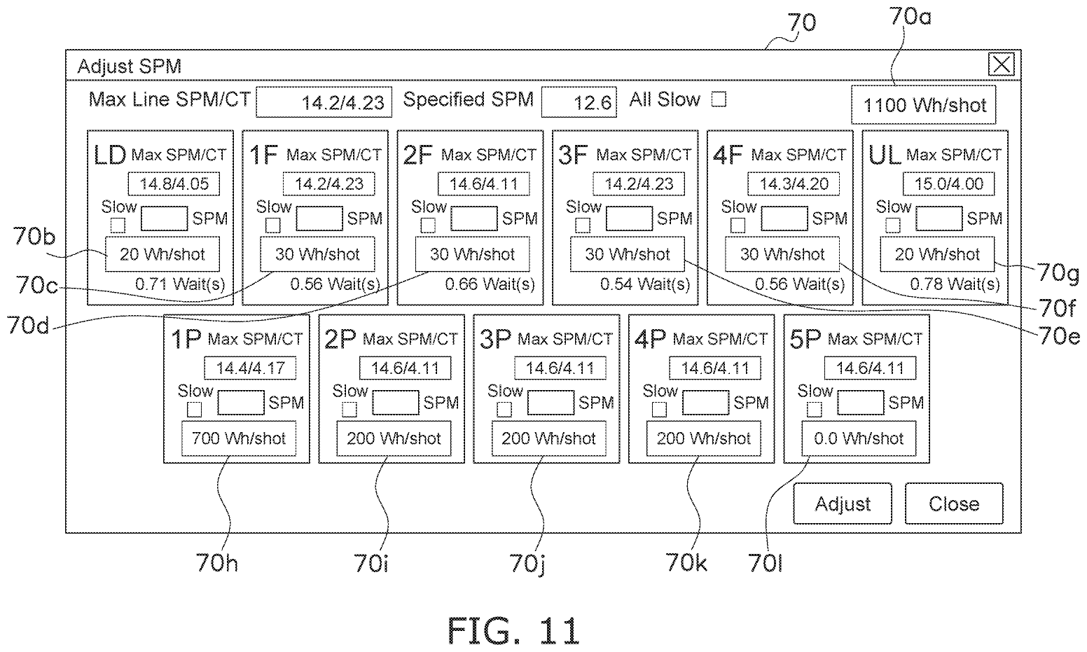

Next, in step S13, the first calculation section 51d calculates the workload of the servo motor. The workload of the servo motor can be calculated by multiplying the torque by the angular velocity. FIG. 10(b) is a diagram showing a graph 61i indicating the change in the workload of the servo motor over time. The vertical axis of FIG. 10(b) represents the workload, and the horizontal axis represents time. The servo motor executes regenerative operation and power running operation, and in FIGS. 10(a) and 10(b), the torque during power running operation is a positive value, and the torque during regenerative operation is a negative value. In addition, when calculating the power consumption from the workload of each device to display the power consumption of each device shown in FIG. 11 described later, in the present embodiment, only the power consumption during power running operation is calculated, and the workload during regenerative operation is regarded as zero and is not taken into consideration. When a power storage device is provided, power storage during regenerative operation may also be considered.

In the present embodiment, the press device 1P is provided with, for example, four servo motors 21, so steps S11 to S13 are executed for each of the four servo motors 21, and the workload of the press device 1P can be calculated by adding up the workloads of all the servo motors. The workload of the press devices 2P to 5P is also calculated in the same manner as the press device 1P.

In addition, the workload is also calculated for each of the feeder devices LD, 1F, 2F, 3F, 4F, and UL. Each of the feeder devices LD, 1F, 2F, 3F, 4F, and UL is provided with the first motor 46, the second motor 47, a servo motor (not shown) for moving the first drive device 31 in the conveying direction X, the first motor 46′, the second motor 47′, and the servo motor (not shown) for moving the second drive device 32 in the conveying direction X. Therefore, by calculating the workload for each of these servo motors and adding up the workloads of all the servo motors, the workload for each of the feeder devices LD, 1F, 2F, 3F, 4F, and UL can be calculated. As described above, the workloads of the first motor 46 and the second motor 47 for moving the crossbar 33 up and down are small compared to the workloads of the servo motor for moving the first drive device 31 in the conveying direction X and the servo motor for moving the second drive device 32 in the conveying direction X, and are therefore ignored here.

As described above. FIG. 7(a) shows the graph 61b of the change over time in the workload of the feeder device LD. FIG. 7(b) shows the graph 62b of the change over time in the workload of the press device 1P. FIG. 7(c) shows the graph 63b of the change over time in the workload of the feeder device 1F. FIG. 7(d) shows the graph 64b of the change over time in the workload of the press device 2P. FIG. 7(e) shows the graph 65b of the change over time in the workload of the feeder device 2F.

As described above, in step S2, the workload of each of the press devices 1P to 5P and the feeder devices LD, 1F, 2F, 3F, 4F, and UL is calculated.

Returning to the simulation method of FIG. 6, in step S3, the second calculation section 51e calculates the workload of the press line 1 by adding up the workloads of the press devices 1P to 5P and the feeder devices LD, 1F, 2F, 3F, 4F, and UL. FIG. 7(f) is a diagram showing a graph 66b indicating the change over time in the workload. which is the sum of the workloads (graphs 61b to 65b) of the press devices 1P to 5P and the feeder devices LD, 1F, 2F, 3F, 4F, and UL. In FIG. 7(f) graphs 61a to 65a are also shown.

Since the press devices 1P to 5P and the feeder devices LD, 1F, 2F, 3F, 4F, and UL are connected to the same factory power source, the power regenerated by any of the devices can be used to power other device that is running at the same time. For example, by adding up the graphs of the workload of each device (for example, the graphs 61b to 65b of the workloads shown in FIGS. 7(a) to 7(e)), the total workload can be calculated by offsetting the power running workload of one device with the regenerative workload generated in the other device.

In step S4, the second calculation section 51e calculates the workload for one cycle of the press line 1, thereby calculating the power consumption per product (workpiece W). Specifically, the second calculation section 51e calculates the workload in a section of time ΔT of one cycle from the total workload, and obtains the power consumption. In FIG. 7(f), the section from time t4 to t41 is shown, but it is not limited to this time. The workload for one cycle of the press line 1 is the same in any section of time ΔT. In addition, in the added-up workload (graph 66), the torque during power running operation is a positive value, and the torque during regenerative operation is a negative value. In this embodiment, when calculating the power consumption from the added-up workload, only the power consumption during power running operation is calculated, and the workload during regenerative operation is regarded as zero and is not taken into consideration. When a power storage device is provided, power storage during regenerative operation may also be taken into consideration. In the simulation method shown in FIG. 6, steps S2, S3, and S4 correspond to an example of a power consumption information calculation step. Steps S3 and S4 correspond to an example of a second calculation step.

Next, in step S5 (an example of a display step), the display control section 51c causes the display section 53 to display the power consumption per product (workpiece W).

FIG. 11 is a diagram showing an example of a display screen 70 displayed on the display section 53. A display portion 70a in the display screen 70 displays the power consumption of the entire press line 1 per product (an example of the power consumption of a press line). In FIG. 11, the display portion 70a shows, for example, 1100 W/shot.

In FIG. 11, the power consumption per cycle of the feeder device LD is shown in a display portion 70b. The power consumption per cycle of the feeder device 1F is shown in a display portion 70c. The power consumption per cycle of the feeder device 2F is shown in a display portion 70d. The power consumption per cycle of the feeder device 3F is shown in a display portion 70e. The power consumption per cycle of the feeder device 4F is shown in a display portion 70f. The power consumption per cycle of the feeder device UL is shown in a display portion 70g. Both the power consumption per cycle and the power consumption per product are expressed in W/shot.

In addition, in FIG. 11, the power consumption per cycle of the press device 1P is shown in a display portion 70h. The power consumption per cycle of the press device 2P is shown in a display portion 70i. The power consumption per cycle of the press device 3P is shown in a display portion 70j. The power consumption per cycle of the press device 4P is shown in a display portion 70k. The power consumption per cycle of the press device 5P is shown in a display portion 70l.

In the present embodiment, since there are phase differences between the press devices 2, the power consumption (70a) of the press line 1 per product is lower than the simple sum of the power consumption (70b to 70l) of each device. In each of the press devices 1P to 5P and the feeder devices LD, 1F, 2F, 3F, 4F, and UL, when calculating the power consumption from the workload, the power consumption is calculated assuming that the power generated by regeneration is zero. On the other hand, since the press devices 1P to 5P and the feeder devices LD, 1F, 2F, 3F, 4F, and UL are connected to the same factory power source, the power regenerated by any of the devices can be used to power other devices that are running at the same time. In this way, in the press line 1, the power consumption is calculated by using the regenerative power generated by any one of the devices to offset the power running consumption of the other devices, so the power consumption of the press line 1 per product is lower than the simple sum of the power consumption of each device.

Incidentally, if no phase difference is provided between the press devices 1P to 5P, it is possible that the regenerative power of the feeder devices LD, 1F, 2F, 3F, 4F, and UL could be used for the press devices. However, because the power consumption of the feeder devices LD, 1F, 2F, 3F, 4F, and UL is smaller than that of the press devices 1P to 5P, providing phase differences between the press devices 1P to 5P can reduce power consumption more than providing no phase difference.

As described above, the simulation device of the present embodiment can display the power consumption of the press line in the generated press line motion, allowing the operator to re-generate or adjust the press line motion while checking the power consumption.

### Features, etc.

The simulation program of the present embodiment is a simulation program that simulates the motion of the press line equipped with the press devices 1P to 5P that press the workpiece W, and causes a computer to execute step S1 and steps S2 to S4. In step S1, the motion of the press line 1 is generated. In steps S2 to S4, information regarding the power consumption of the press line 1 is calculated based on the motion of the press line 1.

Thereby, it is possible to generate the press line motion of which power consumption is reduced.

The simulation program of the present embodiment further includes step S5 (an example of a display step) of displaying the information regarding the calculated power consumption of the press line.

Thereby, it is possible for the operator to generate the motion of the press line 1 while checking the displayed information regarding the power consumption, and to generate the motion of the press line of which power consumption is reduced. The information regarding the power consumption includes power consumption, electricity charges, the amount of reduction in power consumption relative to the maximum operating speed, and the amount of reduction in electricity charges relative to the maximum operating speed.

In the simulation program of the present embodiment, in step S2, the workload of each of the press devices 1P to 5P and the feeder devices LD, 1F, 2F, 3F, 4F, and UL in the motion of the press line 1 is calculated. In steps S3 and S4, the power consumption of the press line 1 is calculated based on the calculated workloads.

In this manner, by calculating the workload of each of the press devices 1P to 5P and the feeder devices LD, 1F, 2F, 3F, 4F, and UL, the information regarding the power consumption of the press line 1 can be calculated.

In the simulation program of the present embodiment, in step S2, the workload of each of the press devices 1P to 5P in the motion of the press line 1 is calculated. In steps S3 and S4, the power consumption of the press line 1 is calculated based on the calculated workloads.

In this manner, by calculating the workload of each of the press devices 1P to 5P, the information regarding the power consumption of the press line 1 can be calculated. In addition, since the press device consumes more power than the feeder device, the approximate power consumption of the press line 1 can be obtained by calculating the power consumption of only the press devices.

In the simulation program of the present embodiment, in steps S3 and S4, the calculated workload of each device is added up to calculate the workload of the press line 1, and the information regarding the power consumption per workpiece W is calculated.

This allows the operator to check the power consumption when producing one workpiece W. When the unit price of electricity is known, the production cost per work W may be displayed instead of or in addition to the power consumption. The production cost corresponds to an example of information regarding power consumption.

In the simulation program of the present embodiment, in step S2, the workloads of the press devices 1P to 5P are calculated by calculating the workloads of the servo motors 21 from the motion of the slide 14 of the press devices 1P to 5P in the motion of the press line 1, and the workload of the press line 1 is calculated by calibrating the workloads of the first motor 46, the second motor 47, the servo motor (not shown) that moves the first drive device 31 in the conveying direction X, the first motor 46′, the second motor 47′, and the servo motor (not shown) that moves the second drive device 32 in the conveying direction X from the motions of the feeder devices LD, 1F, 2F, 3F, 4F, and UL in the motion of the press line 1.

This makes it possible to calculate the workloads of the press devices and the feeder devices.

In the simulation program of the present embodiment, each of the press devices 1P to 5P includes the servo motor 21 that moves the slide 14 up and down. In step S2, the workloads of the press devices 1P to 5P are calculated by calculating the workloads of the servo motors 21 from the motions of the slides 14 of the press devices 1P to 5P in the motion of the press line 1.

This makes it possible to calculate the workloads of the press devices.

In the simulation program of the present embodiment, a phase difference is provided between the motion of the slide 14 of the press device 1P and the motion of the slide of the press device 2P in the press line 1 such that the positions of the slides at a predetermined time are different.

This makes it possible to calculate the power consumption of the press line in which at least two press devices among a plurality of press devices 1P to 5P are driven to move up and down with the phase difference between them.

In the simulation program of the present embodiment, the press devices 1P to 5P are connected to the same factory power supply.

This makes it possible to check the power consumption supplied from the same factory power source. In addition, the electric power regenerated by any one of the press devices 1P to 5P can be used to power another device that is running at the same time. This makes it possible to reduce power consumption in the press line 1 including the press devices 1P to 5P.

The recording medium of the present embodiment is a recording medium on which the simulation program is recorded, and can be processed by the computer.

The simulation method of the present embodiment is a simulation method for simulating the motion of the press line equipped with the press devices 1P to 5P that press a workpiece W, and includes step S1 (an example of a motion generation step) and steps S2 to S4 (an example of a power consumption information calculation step). In step S1, the motion of the press line 1 is generated. In steps S2 to S4, the information regarding the power consumption of the press line 1 is calculated based on the motion of the press line 1.

Thereby, it is possible to generate the press line motion of which power consumption is reduced.

The simulation device 5 of the present embodiment is a simulation device that simulates the motion of the press line equipped with the press devices 1P to 5P that press a workpiece W, and includes the motion generation section 51a and the power consumption calculation section 51b. The motion generation section 51a generates the motion of the press line 1. The power consumption calculation section 51b calculates information regarding the power consumption of the press line 1 based on the motion of the press line 1.

Thereby, it is possible to generate the press line motion of which power consumption is reduced.

### Other Embodiments

Although one embodiment of the present invention has been described above, the present invention is not limited to the above embodiment, and various changes can be made without departing from the gist of the invention.
(A)

In the above embodiment, the press line control device 4 and the simulation device 5 are connected by wire or wirelessly, but they do not have to be connected. For example, the press line motion program generated by the simulation device 5 may be recorded on a recording medium such as an SD card, and the press line control device 4 may acquire the press line motion program by reading the recording medium.
(B)

In the above embodiment, the power consumption of the press line 1 is displayed on the display portion 70a of the display section 53, but this is not limited to the power consumption itself, and any information regarding the power consumption may be displayed. Information regarding power consumption may include CO2 emissions, electricity costs, production costs, reduction in power consumption at maximum operating speed, reduction in CO2 emissions at maximum operating speed. reduction in electricity costs at maximum operating speed, or reduction in production costs at maximum operating speed.
(C)

The press line 1 in the above embodiment includes six feeder devices LD, 1F, 2F, 3F, 4F, and UL, and five press devices 1P to 5P, but the present invention is not limited to this.
(D)

In the above embodiment, the simulation device 5 is arranged separately from the press line 1, but the simulation device 5 may also be incorporated into the press line 1.
(E)

In the above embodiment, the power consumption per product is displayed, but it may be possible to inform the operator by voice or other means without displaying it.
(F)

In the above embodiment, phase differences are provided among a plurality of press devices 2, but phase differences do not have to be provided.
(G)

In addition, the recording medium of the present disclosure is a recording medium on which a program for executing by a computer the operations of all or some of the steps of the simulation method of the present disclosure is recorded, and that is readable by a computer, and such that the read program cooperates with the computer to execute the operations. One mode of use of the program of the present invention may be a mode in which the program is recorded in a recording medium such as a computer-readable ROM and operates in cooperation with the computer. Furthermore, one mode of use of the program of the present invention may be a mode in which it is transmitted through a transmission medium such as the Internet or a transmission medium such as light or radio waves, read by a computer, and operates in cooperation with the computer. Furthermore, the computer of the present invention described above is not limited to pure hardware such as a CPU, but may include firmware, an OS, and also include peripheral devices. Furthermore, the configuration of the present invention may be realized by software or by hardware.

### INDUSTRIAL APPLICABILITY

A simulation program of the present disclosure can provide a simulation program, a recording medium, a simulation method, and a simulation device that enable confirmation of information serving as an index of energy consumption.

### REFERENCE SIGNS LIST

1: Press line
2: Press device
1P to 5P: Press device
3: Feeder device
LD, 1F, 2F, 3F, 4F, UL: Feeder device
4: Press line control device
5: Simulation device
51: Simulation section
51a: Motion generation section
51b: Power consumption calculation section
51c: Display control section
51d: First calculation section
51e: Second calculation section
52: Input section
53: Display section
54: Communications section

1. A simulation program for simulating a motion of a press line including a first press device configured to process a workpiece, the simulation program configured to cause a computer to execute:
a motion generation step of generating the motion of the press line; and
a power consumption information calculation step of calculating information regarding power consumption of the press line based on the motion of the press line.

2. The simulation program according to claim 1, wherein the simulation program is configured to cause the computer to further execute a display step of displaying the information regarding the calculated power consumption of the press line.

3. The simulation program according to claim 1, wherein
the press line further includes a first conveying device configured to convey the workpiece to or from the first press device, and
the power consumption information calculation step includes
a first calculation step of calculating a workload of each of the first press device and the first conveying device in the motion of the press line, and
a second calculation step of calculating the information regarding the power consumption of the press line based on each calculated workload.

4. The simulation program according to claim 1, wherein
the press line further includes a second press device configured to press the workpiece, and
the power consumption information calculation step includes
a first calculation step of calculating a workload of each of the first press device and the second press device in the motion of the press line, and
a second calculation step of calculating the information regarding the power consumption of the press line based on each calculated workload.

5. The simulation program according to claim 3 or 4, wherein
in the second calculation step, information regarding power consumption per workpiece is calculated by adding up each of the workload to calculate a workload of the press line.

6. The simulation program according to claim 3, wherein
the first press device includes a servo motor configured to move a slide up and down,
the first conveying device includes a servo motor as a drive source, and
in the first calculation step, the workload of the first press device is calculated by calculating a workload of the servo motor from a motion of a slide of the first press device in the motion of the press line, and the workload of the first conveying device is calculated by calculating a workload of the servo motor from a motion of the first conveying device in the motion of the press line.

7. The simulation program according to claim 4, wherein
each of the first press device and the second press device includes a servo motor configured to move a slide up and down,
in the first calculation step, the workload of the first press device is calculated by calculating a workload of the servo motor from a motion of the slide of the first press device in the motion of the press line, and the workload of the second press device is calculated by calculating a workload of the servo motor from a motion of the slide of the second press device in the motion of the press line.

8. The simulation program according to claim 4, wherein
a phase difference is provided between a motion of a slide of the first press device and a motion of a slide of the second press device in the motion of the press line, such that positions of the slides at a predetermined time are different.

9. The simulation program according to claim 4, wherein
the first press device and the second press device are connected to same factory power source.

10. A recording medium on which a simulation program according to claim 1 is recorded, the recording medium being processable by a computer.

11. A simulation method for simulating a motion of a press line including a first press device configured to process a workpiece, the simulation method comprising:
a motion generation step of generating the motion of the press line; and
a power consumption information calculation step of calculating information regarding power consumption of the press line based on the motion of the press line.

12. A simulation device configured to simulate a motion of a press line including a first press device configured to process a workpiece, the simulation device comprising:
a motion generating section configured to generate the motion of the press line; and
a power consumption information calculation section configured to calculate information regarding power consumption of the press line based on the motion of the press line.
